(19) United States
(12) Patent Application Publication
(10) Pub. No.: US 2002/0108545 A1
(43) Pub. Date: Aug. 15, 2002

(54) Apparatus for dispensing liquid fluid into a soil

(76) Inventor: Tilmann Von Dem Knesebeck, Buchholz (DE)

Correspondence Address: HENRY M FEIEREISEN, 350 FIFTH AVENUE, SUITE 3220, NEW YORK, NY, 10118, US

(21) Appl. No.: 09/853,024

(22) Filed: May 10, 2001

Related U.S. Application Data
(60) Provisional application No. 60/268,634, filed on Feb. 14, 2001.

(51) Int. Cl. A01C 23/00

(52) U.S. Cl. 111/118

(57) ABSTRACT

Apparatus for dispensing a liquid fluid into a soil, includes a stationary feed assembly connected to a vehicle and mounted on an axle, and a discharge assembly configured for rotation about the axle relative to the feed assembly. The discharge assembly includes a plurality of tubes having tips for sequential penetration of the soil and dispensing of liquid fluid into a soil, wherein the feed assembly has a supply zone for liquid fluid, with the supply zone located in an area outside the axle.

### CROSS-REFERENCES TO RELATED APPLICATIONS

This application claims the benefit of prior filed provisional application, Appl. No. 60/268,634, filed Feb. 14, 2001, pursuant to 35 U.S.C. 119(e).

### BACKGROUND OF THE INVENTION

The present invention relates, in general to a soil treatment device, and more particularly to an apparatus for dispensing liquid fluid, preferably a liquid fertilizer or like medium, into a soil.

Conventional soil treatment devices of the type involved here for introduction of flowable or liquid fertilizer into the soil of a field, lawn, plantation or the like, typically include dispenser wheels which are supported for rotation about horizontal axles. The axles are mounted to the frame of a tractor, which moves the dispenser wheels across the soil being treated. The tractor pulls a trailer in the form of a tank, which contains liquid fertilizer under pressure for conduction via hoses to the axles which are stationary with respect to the frame and form a component of the feed assembly. Liquid fertilizer can be discharged via a bore of an axle of the feed assembly into tubes which project like spokes radially outwards from the discharge assembly that orbits or rotates about the stationary axle, and which are secured to a ring-shaped carrier, so as to give the impression of a rotating dispenser wheel as a consequence of the radial spoke-like disposition of the tubes. The rotating motion of the discharge assembly and the tubes is implemented by the penetration of the tips of the tubes, projecting beyond the ring-shaped carrier, into the soil, as the tractor travels. The depth of penetration can be set by a height-adjustment of the axles in the supporting frame. A linear travel of the tractor is also translated into a linear motion of the axles, resulting in a rotating motion of the tubes and thereby successive penetration into the soil to thereby release the liquid fertilizer. After dispensing the liquid, the respective tube moves again out of the soil, while the next following tube enters the soil to thereby apply an amount of fertilizer to the soil and subsequently moves out, and so on.

A control of the correct moment of application of fertilizer under pressure to the tube that is situated at any time in the soil, is realized by providing bores, which are respectively assigned to the tubes, and move past the bore of the feed assembly, when the discharge assembly rotates, so that each tube is supplied with liquid fertilizer at the correct point in time. As the bores of the rotating discharge assembly and of the stationary feed assembly are aligned only momentarily, the connection to the fertilizer reservoir is correspondingly short, thereby limiting the dispensing output. Moreover, a migration of chemically and metallurgically aggressive liquid fertilizer to rolling-contact bearings, by which the rotating discharge assembly is supported on the axle of the feed assembly, cannot be prevented. As a result, the bearings are subject to substantial corrosion and ultimately to a seizing in a fairly short period.

In addition, the tips of the tubes of conventional dispensing devices are also subject to rapid wear. In the event of damage to the tubes, e.g. by excessive bending, a quick replacement of the tubes cannot be entertained.

All these shortcomings of conventional dispensing devices, involved here, render their application useful during only one season, after which they must be maintained through cumbersome and expensive replacement of worn-out parts. As a consequence of the fairly small feed output of fertilizer, the overall fertilizing performance is unsatisfactory, in particular when taking into account the substantial investment to acquire such a device. Also, conventional dispensing devices are unsuitable to introduce a fertilizer mixture as individual fertilizer components oftentimes react with one another in the tank. In addition, conventional feed assemblies for liquid fluids are incapable to feed liquid herbicides and/or insecticides above ground. In cases, where several types of fertilizer and/or additional insecticides and/or herbicides are supplied, conventional dispensing devices require a field trip for each material, thus further impairing the overall efficiency, especially when considering the already limited output performance.

It would therefore be desirable and advantageous to provide an improved apparatus for dispensing liquid fluid, obviating prior art shortcomings.

### SUMMARY OF THE INVENTION

According to one aspect of the present invention, an apparatus for dispensing a liquid fluid into a soil includes a stationary feed assembly connected to a vehicle and fixedly mounted on an axle, and a discharge assembly configured for rotation about the axle relative to the feed assembly in a rotation direction, with the discharge assembly including a plurality of tubes having tips for sequential penetration of the soil and dispensing of liquid fluid into a soil, wherein the feed assembly has a supply zone for liquid fluid, with the supply zone located in an area away from the axle.

According to another feature of the present invention, the feed assembly has at least one channel for conducting liquid fluid, with the channel fluidly connectable in succession with passageways of the rotating discharge assembly, whereby the passageways are connected to the tubes in one-to-one correspondence. Hereby, the channel of the feed assembly is fluidly connected to the one passageway of the discharge assembly that at any time projects into the soil and is destined for dispensing liquid fluid.

According to another feature of the present invention, the feed assembly has a chamber, which is fluidly connected to the channel for extending the channel in the rotation direction in a region adjacent the discharge assembly with its passageways. In this way, the dispensing output for liquid fertilizer can be significantly enhanced. Of course, it is also possible to extend the orbiting passageways of the discharge assembly in rotation direction in areas adjacent the feed assembly. Suitably, the chamber of the feed assembly has a length which is slightly smaller than a distance between neighboring passageways of the discharge assembly such that a degree of overlap between the chamber of the feed assembly and the passageways of the discharge assembly is maximized.

Corrosion of bearing elements for support of the revolving discharge assembly, as a result of exposure to liquid fertilizer can be prevented by arranging the bearing elements at a central location on the axle of the stationary feed assembly and at a distance to the supply zone. In this fashion, the bearings can be substantially shielded from exposure to aggressive liquid fertilizer. Suitably, the bearing elements are configured as rolling-contact bearings, provided with axial sealing washers and filled, preferably with oil. It may be suitable, to provide at least one seal between the supply zone and a bearing element for separating the bearing elements from the liquid fertilizer, whereby the surrounding area of the seal is fluidly connected to the outside via a drain channel.

According to another feature of the present invention, the feed assembly may have a further supply zone which is also located in an area away from the axle, whereby the discharge assembly revolves also about the further supply zone, with the tubes fluidly communicating temporarily with both supply zones for mixture of different liquid fluids. In this way, liquid fertilizers of different compositions, which cannot be mixed in a common tank or can be mixed only at great problems, e.g. because of undesired chemical reactions, precipitation or crystallization, can now be contained in separate tanks and then conducted separately until united as a mixture only in the discharge assembly for immediate release through the tubes for application on the desired site in the soil. Thus, a single trip is possible for simultaneous introduction of several liquid fertilizers into the soil.

Making the tips of the tubes of hard metal can significantly reduce the very annoying wear of the pointed tube ends. Suitably, the tips of the tubes can be detachably secured to the tubes, e.g., by screwed connections, so as to realize easy option of replacement.

According to another feature of the present invention, the discharge assembly has a plurality of check valves, with each of the check valves being disposed in an end portion of a corresponding one of the tubes, whereby the check valves and the tubes are placed into one-to-one correspondence. In this manner, escape of liquid fertilizer from the tubes as a result of centrifugal forces at higher speeds can be prevented.

According to another feature of the present invention, the discharge assembly has a hub, with the tubes so detachably secured, e.g. through a screw connection, to the hub as to project outwardly from the hub. Suitably, the end portions of the tubes can be restrained by a ring-shaped mounting, whereby the end portions of the tubes can be detachably secured, e.g. screwed, to the mounting. The tubes can then be easily replaced through simple unscrewing, when damaged, e.g. through excessive bending.

The dispensing apparatus according to the present invention can be advantageously exploited for supply of further liquids, e.g. insecticides and/or herbicides, so that the need for separate spraying facilities and additional personnel can be eliminated, while still allowing a simultaneous application of liquid fertilizer into the soil or onto growing plants. Suitably, the feed assembly includes, in addition to the supply zone, a further supply zone for conducting a further liquid fluid, in particular herbicides and/or insecticides. Hereby, the tubes of the discharge assembly are so fluidly connected with the feed assembly that some tubes are provided for conducting liquid fertilizer and some tubes are provided for conducting the further liquid fluid. Suitably, the tubes for conducting the further liquid fluids may terminate above the surface of the soil, when these fluids, such as insecticides and/or herbicides, should be applied upon the soil and/or growing plants. The liquid fluid is supplied under pressure to the feed assembly and the tubes.

According to another feature of the present invention, the feed assembly and/or the discharge assembly may have a substantially rotation symmetrical configuration.

A dispensing apparatus according to the present invention allows introduction of liquid fluids of any composition, preferably liquid fertilizers but also liquid pesticides and/or weed killers, into the soil, so long as the fluids are able to flow freely. Damage due to corrosion of those parts that come into contact with the liquid fluid can be eliminated by making those parts of corrosion-resistant steel (special steel) or aluminum.

According to another feature of the present invention, the feed assembly and the discharge assembly are secured by means of at least one spring, e.g. a leg spring, to a carrier. Preferred however is the application of two leg springs arranged in side-by-side disposition. When hereby the leg springs are coiled in opposite directions, movements perpendicular to the actual spring motions are possible to a certain extent, so that the tubes are able to deflect when striking an obstacle. Suitable, the leg springs have a short leg mounted to the carrier, and a long leg connected to one end of one or more links having another end adapted for attachment of the feed assembly and the discharge assembly.

A dispensing apparatus according to the present invention has many advantages. The off-center supply of liquid fertilizer and/or other liquids permits for a superior sealing action, in particular of the bearings. As a consequence of the prolongation of the effective outlet zone of the channel in the feed assembly, maximum amounts of liquids can be supplied to the passageways of the discharge assembly and thus of the tubes. The arrangement of a further supply zone in the feed assembly allows mixing in the discharge assembly of such different liquid fertilizers that cannot be transported jointly in tanks. Finally, it is also possible, to dispense liquid fertilizer below ground while applying liquid herbicides and insecticides above ground at the same time.

### BRIEF DESCRIPTION OF THE DRAWING

Other features and advantages of the present invention will be more readily apparent upon reading the following description of preferred exemplified embodiments of the invention with reference to the accompanying drawing, in which:

FIG. 1 is a sectional view of one embodiment of a dispensing apparatus according to the present invention;

FIG. 2 is a side view of the dispensing apparatus, taken in the direction of arrow II in FIG. 1;

FIG. 2a is a schematic illustration, on an enlarged scale, of the dispensing apparatus taken in the direction of arrow II′ in FIG. 2;

FIG. 3 is a simplified, schematic cutaway view, on an enlarged scale, of a sliding block for incorporation in the dispensing apparatus of FIG. 1;

FIG. 4 is a sectional view of the sliding block, taken along the line IV-IV in FIG. 3;

FIG. 5 is a sectional view of the sliding block, taken along the line V-V in FIG. 3; and

FIG. 6 is a sectional view of another embodiment of a dispensing apparatus according to the present invention.

### DETAILED DESCRIPTION OF PREFERRED EMBODIMENTS

Throughout all the Figures, same or corresponding elements are generally indicated by same reference numerals.

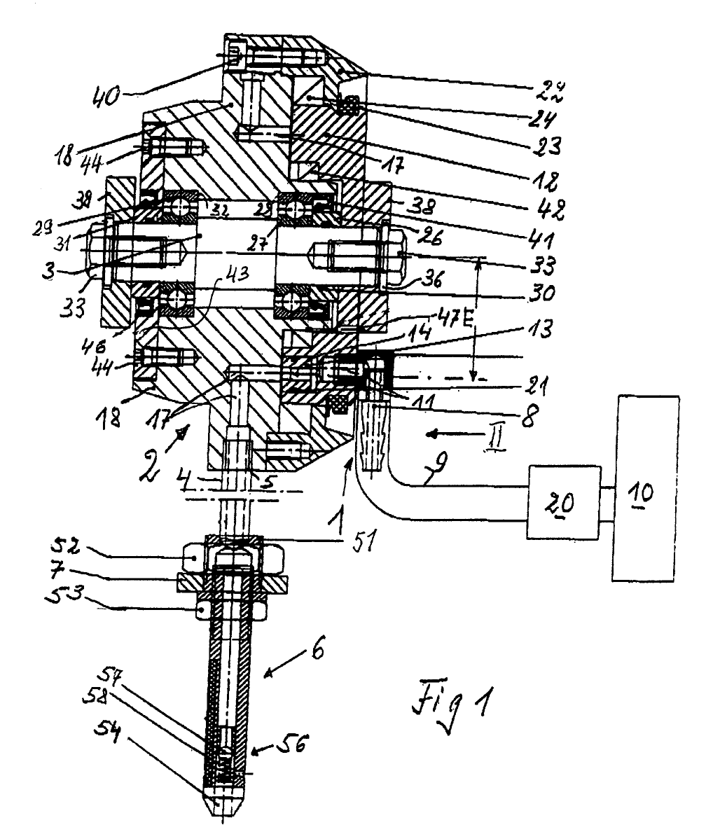

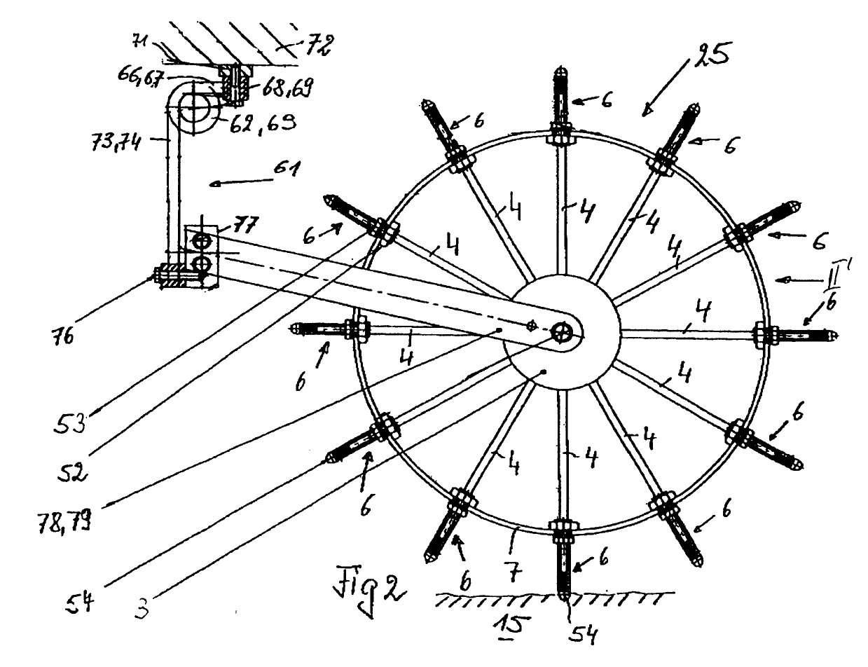

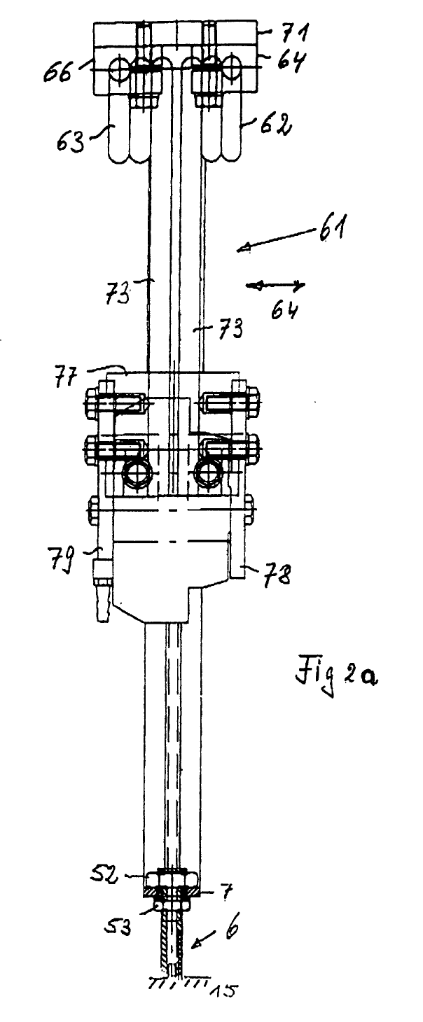

Turning now to the drawing, and in particular to FIG. 1, there is shown a sectional view of one embodiment of a dispensing apparatus according to the present invention, including a feed assembly, generally designated by reference numeral 1, and a discharge assembly, generally designated by reference numeral 2. The feed assembly 1 includes a horizontal axle 3 which is fixedly mounted to a frame structure 72 of a, not shown, tractor which is provided with a tank 10, shown only schematically and containing a liquid fluid, e.g. liquid fertilizer. The frame 72 is moved by the traveling tractor across a field, lawn, plantation of like area, which may be empty or grown with plants. A metering device 20 supplies liquid fluid under pressure from the tank 10 to a supply zone 8 of the feed assembly 1 via a hose 9. Interacting with the feed assembly 1 in a manner to be described hereinafter is the discharge assembly 2 which includes a plurality of tubes 4 radially projecting out from a hub 18 in spoke-like manner, as shown in FIG. 2, thereby forming a so-called “dispenser wheel”, generally designated by reference numeral 25.

For ease of illustration, FIG. 1 shows only one tube 4, when in fact the dispenser wheel 25 has a plurality of tubes 4 spaced about the circumference of the hub 18, as shown in FIG. 2. Each tube 4 is mounted at a hub-proximal end by a screw connection 5 to the hub 18 of the feed assembly 2. At the hub-distal end, each tube 4 is welded to a receptacle 51, which is secured by a fastening screw 52 to the ring-shaped mounting 7, for threaded engagement of the end portion 6 of the tube 4. A counternut 53 secures the end portion 6 in place. The end portion 6 of each tube 4 has soldered thereon a tip 54, which is suitably made of hard metal to substantially eliminate a risk of damage, even when the tip 54 strikes against a rock or like obstacle. Even in the unlikely event, a tube 4 is bent during operation, a replacement of the tube 4 can easily be carried out by simply unscrewing the damaged tube 4 from the mounting 7. When the end portion 6 of a tube 4 is damaged, this end portion 6 can be detached from the receptacle 51 in its entirety.

The hub 18 is formed with a plurality of channel-forming bores 17 in fluid communication with the tubes 4 in one-to-one correspondence. At fertilization, the frame structure 72 is moved by the tractor over an empty or planted field, lawn, plantation or like area, whereby liquid fertilizer is introduced into soil 15 via end portions 6 of the tubes 4. As the tractor advances, the discharge assembly 2 is caused to rotate relative to the stationary feed assembly 1 as the tubes 4 successively penetrate with their tips the soil 15 to dispense liquid fertilizer for a certain time, and leave again the soil 15. The dispenser wheel 25 includes a ring-shaped mounting 7 for attachment, e.g. through bolting, of the end portions 6 of the tubes 4. The revolving motion of the discharge assembly 2 is implemented by a horizontal movement of the axle 3 and penetration of the tubes 4 with their end portions 6 into the soil 15 during advance of the, not shown, tractor.

The stationary axle 3 of the feed assembly 1 may be made of e.g. special steel and, unlike prior art construction, is not configured for delivery of liquid fertilizer. The actual delivery system of the feed assembly 1 includes the supply zone 8, which is disposed eccentric to the axle 3 at a distance E. The feed assembly 1 includes a flange 12 which is made of special steel or aluminum and formed with a channel in the form of a bore 11 in fluid communication with the hose 9. A sliding block 13 is received in the flange 12 and interacts with the bore 11. The sliding block 13 is suitably made of polymetylenoxide (POM) material and forms a good sliding combination with the hub 18, which is made of metal, e.g. hardened special steel or aluminum, and moves or glides upon the sliding block 13.

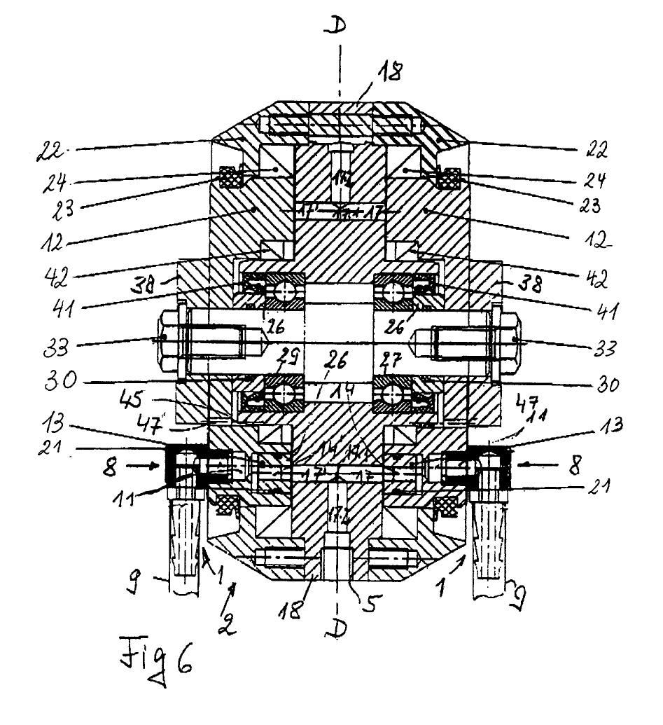

As shown in FIG. 3, the sliding block 13 is formed with an elongate chamber 16 which is fluidly connected with the bore 11 via a further channel 14 (see also FIG. 5) in the flange 12. The chamber 16 is so sized in length as to be slightly smaller than the distances between two neighboring bores 17 in the hub 18 of the discharge assembly 2. As a consequence of the enlargement of the bore 14 in rotating direction of the discharge assembly 2 by means of the chamber 16, the bores 17 are respectively fluidly connected with the supply zone 8 of the feed assembly 1, as they pass in succession the chamber 16 during revolution of the dispenser wheel 25 of the discharge assembly 2, over a significantly longer period for conduction of liquid fertilizer into the associated tubes 4. Of course, the kinematically reverse configuration may also be possible, i.e. to use the distances between the bores 17 as enlargement chambers to increase the overlap period of the bores 17 and the chamber 16. However, such configuration is more complicated compared to an enlargement of the stationary chamber 16 only, in the feed assembly 1.

As stated above, as the dispenser wheel 25 of the discharge assembly 2 rotates, the bores 17 move past the chamber 16 one after the other so as to receive liquid fertilizer for conduction to the one tubes 4 that have entered the soil 15.

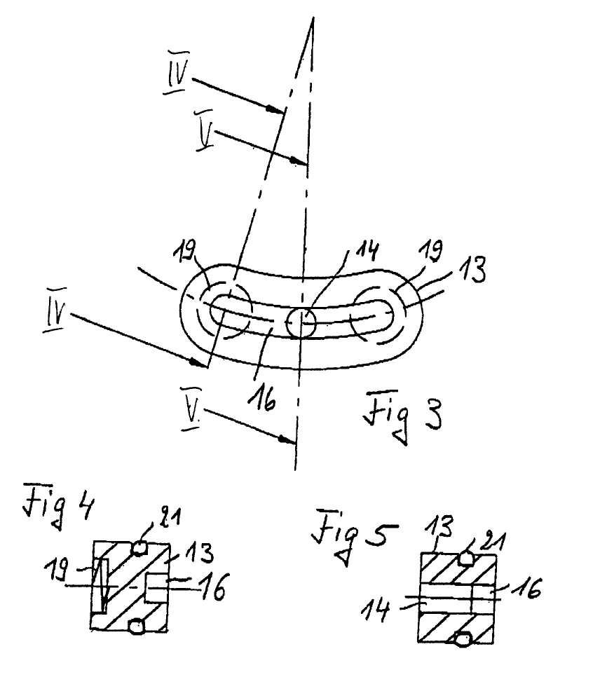

The sliding block 13 is pressed by two springs 19 against the hub 18 of the discharge assembly 2. A sealing ring in the form of an O-ring 21 (FIG. 4) seals the chamber 16 against escape of liquid fertilizer.

Referring back to FIG. 1, it can be seen that the discharge assembly 2 is further provided with a conjointly rotating attachment piece 22 which may be made of metal, e.g. aluminum or special steel, and is mounted to the hub 18 by hexagonal socket screws 40. The attachment piece 22 sealingly rests radially upon the stationary flange 12 between a fixed stiffening ring 23 and an annular gasket 24, with the stiffening ring 23 and the gasket 24 providing a seal between the flange 12 and the rotating attachment piece 22. A spacer ring 26 made of hardened special steel is placed in surrounding relationship to the axle 3 axially adjacent the flange 12 to push a rolling-contact bearing in the form of a ball bearing 27, disposed between the fixed axle 3 and the revolving hub 18, against a shoulder 28 of the hub 18. The spacer ring 26 is formed with a pocket for receiving an O-ring 30 to seal against ingress of liquid fertilizer. A second rolling-contact bearing in the form of ball bearing 29 is disposed at an axial distance to the ball bearing 27 and pushed by a spacer ring 31 against a shoulder 32 of the hub 18. The attachment of the discharge assembly 2 to the feed assembly 1 is implemented by tightening hexagonal socket screws 33 via washers 36 and pressure rings 38 on opposite ends of the axle 3 to apply a required compression force.

Although not shown in detail, the ball bearings 27, 29 for rotatably supporting the discharge assembly 2 upon the axle 3 are suitably sealed in axial direction by, not shown, sealing washers and filled, preferably, with oil.

A sealing ring 41 is disposed between the hub 18 of the discharge assembly 2 and the spacer ring 26, and a sealing ring 46 is placed between the spacer ring 31 and a lid 43, which is bolted by screws 44 to the hub 18. To safely drain liquid fertilizer migrating past the sealing rings 41, 42 before reaching the ball bearing 27 and thus to prevent possible corrosive damage, a drain channel 47 is provided in surrounding region of the sealing rings 41, 42 in the hub 18 and the flange 12 for drainage to the outside.

Referring again to FIG. 1, it can be seen that the end portion 6 of each tube 4 has incorporated therein a check valve assembly, generally designated by reference numeral 56, for preventing an escape of liquid fertilizer from the tube 4 as a result of noticeable centrifugal forces at higher tractor speeds. The check valve assembly 56 includes a ball 57, which is biased by a spring 58 against a seat such that during desired dispensing of liquid fertilizer the applied pressure is able to remove the ball 57 from the seat in opposition of the spring 58 and thereby allow application of liquid fertilizer into the soil 15.

Turning now to FIGS. 2, 2a, there is shown a resilient suspension, generally designated by reference numeral 61, of the dispenser wheel 25 of the discharge assembly 2. The suspension 61 includes two leg springs 62, 63, each having two windings, whereby the windings of the leg springs 62, 63 run in opposite directions, thereby realizing a desired mobility of the springs 62, 63 in the direction of double arrow 64 (FIG. 2a) so that the tips 54 of the tubes 4 are able to laterally deflect when striking against an obstacle. Each of the leg springs 62, 63 has a short leg 66 and a long leg 73, with the short leg 66 secured in a spring clamp 68 connected via a mounting plate 71 to the frame structure 72 of the tractor. The long leg 73 of each of the leg springs 62, 63 is secured in a spring clamp 76 which is coupled to a connection flange 77 for attachment of one end of links 78, 79 (FIG. 2a). The other end of the links 78, 79 is mounted to the axle 3 of the feed assembly 1 by the screws 33 for support of the discharge assembly 2 with the dispenser wheel 25 via the ball bearings 27, 29. Thus, the function of the bearings 27, 29, on the one hand, and the securement of the dispenser wheel 25 upon the links 78, 79 is separated from one another. The resilient suspension 61 for the dispenser wheel 25 is simple in structure and yet robust and reliable in operation as the need for expensive and sensitive spring elements and balancers, as utilized in prior art constructions, is eliminated.

The dispensing apparatus according to the present invention operates as follows: Liquid fluid, such as liquid fertilizer is conducted under pressure via the hose 9 from the tank 10 of the, not shown, tractor via the dispenser 20 to the supply zone 8 of the feed assembly 1 and flows via the bore 11 into the sliding block 13 and into the enlarged chamber 16. The discharge assembly 2 rotates so that the tubes 4 successively penetrate the soil 15 with their end portions 6 and subsequently leave the soil 15 again. Thus, the attachment piece 22 and the hub 18 revolve around the stationary axle 3. As the dispenser wheel 25 rotates, the bores 17 in the hub 18 move in succession past the stationary chamber 16 of the feed assembly 1 and receive liquid fertilizer, which is then conducted to the pertaining tubes 4 that engage the soil 15 at that time, for release through the end portions 6 into the soil 15. As a consequence of the enlarged size of the chamber 16, the supply output can be maximized. In addition, the eccentric disposition of the supply zone 8 and the resultant possibility to arrange sealing elements behind one another, substantially eliminates aggressive liquid fluids from reaching the bearings 27, 29. Optionally, the bearings 27, 29 have incorporated therein further seals for additional safety concerns. Liquid fluid, migrating past the sealing rings 41, 42 is drained to the outside via the drain channel 47.

In the unlikely event, the extremely wear-resistant tip 54 of the end portion 6 of a tube 4 hits an obstacle, e.g. a rock, and becomes damaged, replacement is easy through simple unscrewing the damaged end portion 6. The dispensing apparatus according to the present invention realizes therefore a better supply of liquid fertilizer while yet being less susceptible to malfunction and thus less prone to repair. These factors are crucial in vehicles used for fertilization.

Turning now to FIG. 6, there is shown a sectional view of another embodiment of a dispensing apparatus according to the present invention, useful for delivering two different liquid fluids from separate, not shown, tanks. Parts corresponding with those in FIG. 1 are denoted by identical reference numerals and not explained again. In this embodiment, provision is made for two separate supply systems for the liquid fluids which are united in a common outlet channel of the discharge assembly 2 immediately before discharge into the soil 15. The dispensing apparatus of FIG. 6 is thus provided with the single discharge assembly 2 in a central location and two feed assemblies 1 arranged as mirror images of one another on either side of the discharge assembly 2 with respect to a center line D. Different liquid fluids are conveyed through the hoses 9 from the separate tanks to the respective supply zones 8. The liquids are respectively conducted via the bores 11 to the sliding blocks 13 and via the enlarged chambers 16 into the passing bores 17 of the common discharge assembly 2. The liquids incoming from opposite sides are united at a region, designated by reference numeral 17.1, to flow together via common channels 17.2 into the pertaining tubes 4. As a mixing of the liquids occurs only shortly before being discharged from the dispenser wheel 25 of the discharge assembly 2, harmful reactions of the liquids with one another is precluded. Thus, a single field trip can be used to simultaneously deliver different liquids.

Persons skilled in the art will understand that the dispensing apparatus, described herein, can certainly be so modified that different liquids, e.g. liquid fertilizer, on the one hand, and liquid herbicides and/or insecticides, on the other hand, can be supplied at a same time, whereby the channels 17 of one supply zone 8 for one liquid are separated from the channels 17 of the other supply zone 8 for the other liquid, and conducted separately to different tubes 4 of the dispenser wheels 25. Thus, some of the tubes 4 are fluidly connected for receiving liquid fertilizer and enter the soil 15, as described above, while other tubes 4 are fluidly connected for receiving liquid herbicides and/or insecticides and are so configured as to terminate above ground to allow application, e.g. spraying, of liquid herbicides and/or insecticides onto the soil 15 or on plants growing on the soil 15. Separate field trips become unnecessary, thereby further enhancing the utility of the apparatus according to the present invention.

While the invention has been illustrated and described as embodied in an apparatus for dispensing liquid fluid into a soil, it is not intended to be limited to the details shown since various modifications and structural changes may be made without departing in any way from the spirit of the present invention.

What is claimed as new and desired to be protected by Letters Patent is set forth in the appended claims:

What is claimed is:

1. Apparatus for dispensing a liquid fluid into a soil, comprising:
a stationary feed assembly connected to a vehicle and fixedly mounted on an axle, said feed assembly having a supply zone receiving liquid fluid and located at an area away from the axle; and
a discharge assembly configured for rotation about the axle relative to the feed assembly in a rotation direction, said discharge assembly including a plurality of tubes having tips for sequential penetration into the soil and application of liquid fluid into the soil.

2. The apparatus of claim 1, wherein the feed assembly has at least one channel for conducting liquid fluid, said channel fluidly connectable in succession with passageways of the rotating discharge assembly, with the passageways connected to the tubes in one-to-one correspondence.

3. The apparatus of claim 2, wherein the discharge assembly so revolves with respect to the feed assembly that the channel of the feed assembly is fluidly connected to the one passageway of the discharge assembly that projects into the soil and is ready for dispensing liquid fluid.

4. The apparatus of claim 2, wherein the feed assembly has a chamber which is fluidly connected to the channel for extending the channel in the rotation direction in a region adjacent the discharge assembly with its passageways.

5. The apparatus of claim 4, wherein the chamber of the feed assembly has a length which is slightly smaller than a distance between neighboring passageways of the discharge assembly such that a degree of overlap between the chamber of the feed assembly and the passageways of the discharge assembly is maximized.

6. The apparatus of claim 1, and further comprising bearing means for centered support of the discharge assembly upon the axle at a distance to the supply zone.

7. The apparatus of claim 6, wherein the bearing means includes a rolling-contact bearing with axial sealing washers.

8. The apparatus of claim 6, wherein the bearing means includes a bearing element and at least one seal disposed between the supply zone and the bearing element and having a surrounding area communicating with a drain channel to the outside.

9. The apparatus of claim 1, wherein the feed assembly includes a further such supply zone which is located in an area away from the axle, said discharge assembly rotating also about the further supply zone, with the tubes fluidly communicating temporarily with both supply zones for mixture of different liquid fluids.

10. The apparatus of claim 1, wherein the tips of the tubes are made of hard metal.

11. The apparatus of claim 1, wherein the discharge assembly has a plurality of check valves, each of the check valves being disposed in an end portion of a corresponding one of the tubes, whereby the check valves and the tubes are placed into one-to-one correspondence.

12. The apparatus of claim 1, wherein the discharge assembly has a hub, said tubes being so detachably secured to the hub as to project outwardly from the hub.

13. The apparatus of claim 12, wherein each of the tubes is secured to the hub by a screw connection.

14. The apparatus of claim 12, wherein the discharge assembly includes a ring-shaped mounting for retaining end portions of the tubes, said end portions of the tubes being detachably secured to the mounting.

15. The apparatus of claim 1, wherein the liquid fluid conducted to the supply zone is a liquid fertilizer, said feed assembly including a further supply zone for conducting a further liquid fluid.

16. The apparatus of claim 15, wherein the further liquid fluid is a liquid selected from the group consisting of herbicide and insecticide.

17. The apparatus of claim 15, wherein the tubes of the discharge assembly is so fluidly connected with the feed assembly that some tubes are provided for conducting liquid fertilizer and some tubes are provided for conducting the further liquid fluid.

18. The apparatus of claim 17, wherein the tubes for conducting liquid fertilizer and the tubes for conducting the further liquid fluid are arranged to the discharge assembly in alternating relationship.

19. The apparatus of claim 17, wherein the tubes for conducting the further liquid fluid terminate at a location above a surface of the soil.

20. The apparatus of claim 1, wherein the liquid fluid is supplied under pressure to the feed assembly and the tubes.

21. The apparatus of claim 1, wherein at least one of the feed assembly and the discharge assembly has a substantially rotation symmetrical configuration.

22. The apparatus of claim 1, and further comprising spring means for securing the feed assembly and the discharge assembly to a carrier.

23. The apparatus of claim 22, wherein the spring means includes a leg spring.

24. The apparatus of claim 22, wherein the spring means includes two leg springs arranged in side-by-side disposition and coiled in opposite directions.

25. The apparatus of claim 23, wherein the leg spring has a short leg mounted to the carrier, and a long leg connected to one end of at least one link having another end for attachment of the feed assembly and the discharge assembly.

26. A soil treatment apparatus, comprising:
a vehicle, having a frame, for travel above soil;
a feed assembly connected to the frame and fixedly mounted on an axle, said feed assembly having passageway means at a location away from the axle for receiving liquid fluid; and
a discharge assembly connected to the feed assembly for rotation about the axle relative to the feed assembly, when the vehicle travels in an operating direction, said discharge assembly including a plurality of tubes projecting radially outwards in spaced-apart disposition for sequential penetration into the soil as the discharge assembly rotates, said tubes being so fluidly connected to the feed assembly that liquid fluid is fed to the tubes for application of liquid fluid into the soil only when the tubes penetrate the soil.

27. The apparatus of claim 26, wherein the passageway means includes at an interface with the discharge assembly an elongate chamber extending along a partial area of the interface for fluid communication with the tubes as the tubes move past the chamber during rotation of the discharge assembly.

28. The apparatus of claim 27, wherein the chamber of the feed assembly has a length sufficient to permit a stream of liquid fluid to the tubes as they penetrate the soil.

29. The apparatus of claim 26, and further comprising bearing means for rotatable support of the discharge assembly upon the axle, said bearing means being located at a distance to the passageway means.

30. The apparatus of claim 29, wherein the bearing means includes a rolling-contact bearing.

31. The apparatus of claim 29, wherein the feed assembly and the discharge assembly form together a drain channel in proximity of the bearing means for drainage of liquid fluid.

32. The apparatus of claim 26, wherein each of the tubes has a tip made of hard metal.

33. The apparatus of claim 26, wherein the discharge assembly has a plurality of check valves for preventing an escape of liquid fluid as a result of centrifugal forces when the discharge assembly rotates and the tubes are removed from the soil, each of the check valves being disposed in an end portion of a corresponding one of the tubes, whereby the check valves and the tubes are placed into one-to-one correspondence.

34. The apparatus of claim 26, wherein the discharge assembly has a hub, said tubes being detachably secured to the hub.

35. The apparatus of claim 26, wherein the discharge assembly includes a ring-shaped mounting for retaining end portions of the tubes, said end portions of the tubes being detachably secured to the mounting.

36. The apparatus of claim 26, wherein the tubes of the discharge assembly is so fluidly connected with the passageway means of the feed assembly that some tubes are provided for conducting a first liquid fluid and some tubes are provided for conducting a second liquid fluid.

37. The apparatus of claim 26, wherein the liquid fluid is supplied under pressure to the feed assembly and the tubes.

38. The apparatus of claim 26, and further comprising a resilient suspension for connecting the feed assembly to the frame of the vehicle.
